(19) United States
(12) Patent Application Publication
(10) Pub. No.: US 2017/0180290 A1
(43) Pub. Date: Jun. 22, 2017

(54) SELECTIVE CONTENT DISSEMINATION BASED ON SOCIAL MEDIA CONTENT ANALYSIS

(71) Applicant: International Business Machines Corporation, Armonk, NY (US)

(72) Inventors: Silvia C. Sardela Bianchi, Sao Paulo (BR); Paulo R. Cavalin, Rio de Janeiro (BR); Marco A.S. Netto, Sao Paulo (BR); Sergio Varga, Campinas (BR)

(21) Appl. No.: 14/976,133

(22) Filed: Dec. 21, 2015

(51) Int. Cl. H04L 12/58; H04L 29/08

(52) U.S. Cl. CPC H04L 51/12; H04L 67/02; H04L 67/1044; H04L 51/32

(57) ABSTRACT

A computer implemented method for selective dissemination of social media content is provided. The computer implemented method receives social media content associated with a first user at a social networking site and classifies the social media content associated with the first user into at least one social network community. The computer implemented method inhibits access to the social media content associated with the first user by at least one of a second user and another user not within the at least one social network community and outputs for display a first notification to the user.

### BACKGROUND

The present invention generally relates to a computer implemented method, a computer program product, and a method for selective dissemination of social media content based on social media content analysis.

Users of social networking services or programs generally share social media content such as news stories, pictures, videos, and other materials that may be posted to the social networking community. Current social networking services or social networking programs lack fine-grained control over how the social media content is shared.

### SUMMARY

According to an embodiment of the present invention, a computer implemented method for selective dissemination of social media content is provided. The computer implemented method receives social media content associated with a first user at a social networking site and classifies the social media content associated with the first user into at least one social network community. The computer implemented method inhibits access to the social media content associated with the first user by at least one of a second user and another user that is not associated with the at least one social network community and outputs for display a first notification to the user.

According to another embodiment of the present invention, a computer program product for selective dissemination of social media content. The computer program product comprises a computer readable storage medium having program instructions embodied there with. The program instructions are executable by at least one processor to perform a method that classifies a social media content associated with a first user into at least one social network community, responsive to receiving the social media content associated with the first user at the social networking site from a second user. Responsive to a communication associated with the social media content associated with the first user provided by at least one of an owner of the social media content and another user, the method analyzes the communication. The method inhibits access to the social media content by at least one of the second user and another user that is not associated with the at least one social network community and the communication associated with the social media content associated with the first user.

According to yet another embodiment, a system for selective dissemination of social media content. The system includes at least one processor operatively connected to a computer readable storage medium, the at least one processor is programmed to, responsive to the receipt of an social media content associated with a first user at a social networking site from a second user, classify the social media content associated with the first user into at least one social network community. The at least one processor is programmed to analyze a communication associated with the social media content associated with the first user provided by at least one of the second user and another user. The at least one processor inhibits access to the social media content associated with the first user by at least one of the second user and another user that is not associated with the at least one social network community and the communication associated with the social media content associated with the first user. The at least one processor is programmed to output for display a notification to at least one of the first user and the second user.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is an illustrative view of a social network community of a social networking site according to an embodiment of the present invention;

FIG. 2 is a block diagram of a system for selective dissemination of social media content according to an embodiment of the present invention; and

FIG. 3 a flowchart of a method for selective dissemination of social media content according to an embodiment of the present invention.

### DETAILED DESCRIPTION

As stated above, the present invention relates to a computer implemented method, a computer program product, and a method for selective dissemination of social media content based on social media content analysis, which is now described in detail with accompanying figures. It is noted that like reference numerals refer to like elements across different embodiments.

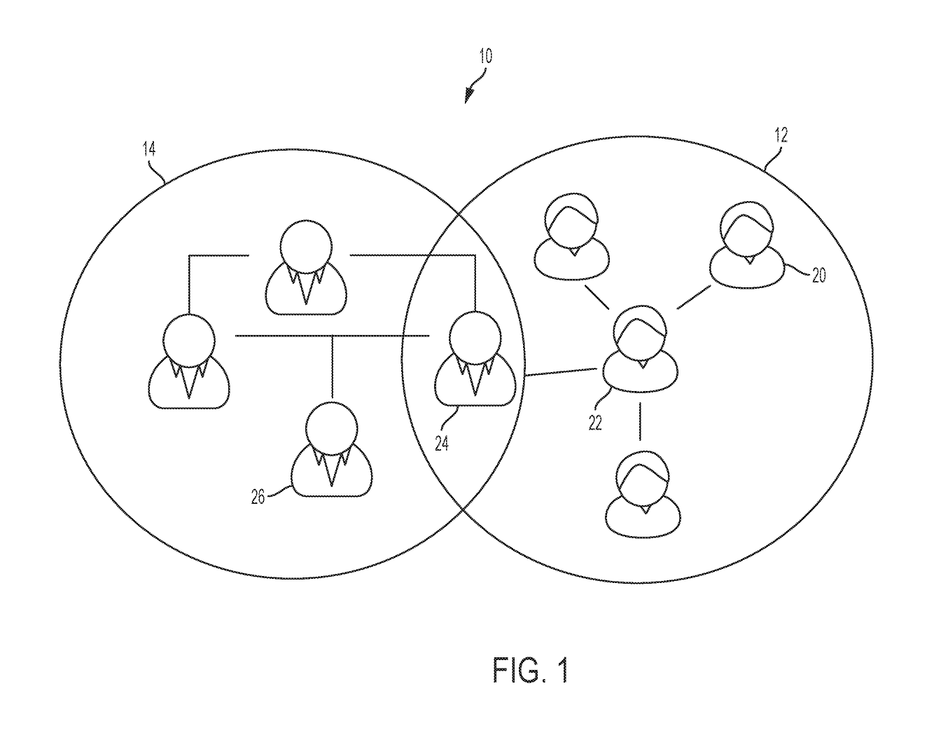

Referring to FIG. 1 illustrates a social media network or a social networking site 10. The social networking site 10 may be a host system or a social networking site such as Facebook™, MySpace™, SoundCloud™, Twitter™, or the like that permits users of the social networking site 10 to upload or share social media content with other users of the social networking site 10. Users are able to access the social networking site 10 via a smart phone, a personal computing device, or other Internet connected device.

The social networking site 10 includes a plurality of social network communities. As illustrated in FIG. 1, the social networking site 10 includes a first social network community 12 and a second social network community 14. Each social network community includes users. Some users may be members of both social network communities, as well as other social network communities.

The first social network community 12 includes a first user 20, a second user 22, and a third user 24. The second social network community 14 includes the third user 24 and another user 26. The second user 22 uploads or provides social media content associated with the first user 20 to the social networking site 10. In an exemplary embodiment, the social media content associated with the first user 20 is an image or a video, associated with the first user 20. Other social media content associated with the first user 20, such as videos, blog posts, articles, or the like is also contemplated. The first user 20 being associated with the social media content may mean that the first user 20 is within the social media content, the first user 20 is identified as within the social media content with a tag or other identifier, or the first user 20 is associated with or mentioned in a comment associated with the social media content.

The social media content is capable of being shared, viewed, re-shared among connected users within the first social network community 12. The social media content may also be shared or viewed among other users within the second social network community 14 connected to a user within the first social network community 12. As such, the social media content may be disseminated within other social network communities. Present social networking sites may include controls that notify the first user 20 of social media content that the first user 20 is identified by another user as within. However, present social networking sites do not include fine-grained control over the dissemination of social media content amongst users of at least one social network community.

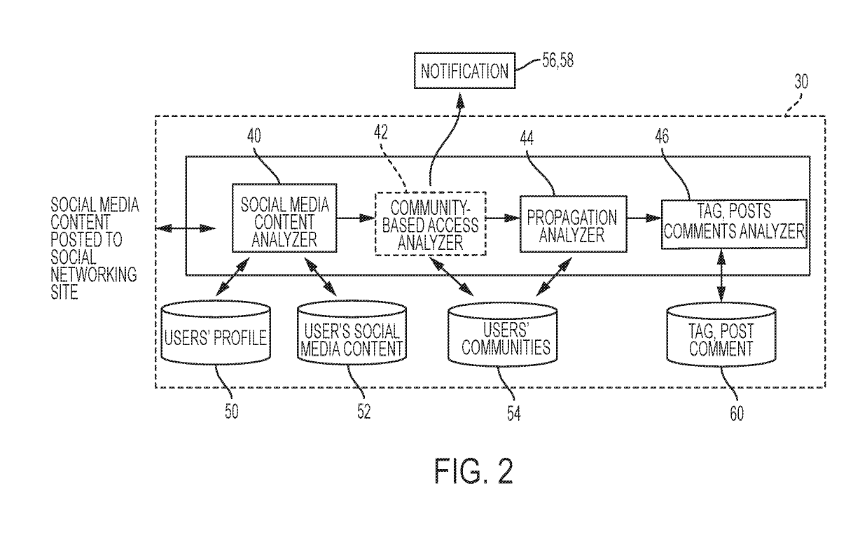

Referring to FIG. 2, a system 30 for the selective dissemination of social media content is provided. The system 30 automatically constrains access to and limits the dissemination of the social media content. The system 30 automatically defines which users, which communities of the first social network community 12, the second social network community 14, and/or other social network communities may view or access the social media content associated with the first user 20.

The system 30 analyzes the social media content and notifies at least one of the first user 20 and other users of the posting or uploading of social media content associated with the first user 20. The system 30 enables the first user 20 to permit or inhibit access to the social media content associated with the first user 20 based on analysis of the social media content associated with the first user 20, tags or postings related to the social media content associated with the first user 20, and reposting or re-uploading of the social media content associated with the first user 20.

The system 30 includes at least one processor operatively connected to a computer readable storage medium. The computer readable storage medium includes at least one of a non-persistent storage and a persistent storage. The computer readable storage medium embodies program instructions executable by the at least one processor or embodies a computer program product that is executable by the at least one processor. The system 30 may be provided as part of the host system of the social networking site 10 or may be provided locally on a user's Internet connected device.

The system 30 includes a social media content analyzer module 40, a community-based access analyzer module 42, a propagation analyzer module 44, and a tag/posts/comments analyzer module 46. The social media content analyzer module 40 analyzes the content of social media that is uploaded or provided to the social networking site 10. The social media content analyzer module 40 receives the social media content that is provided by a user such as the first user 20, the second user 22, or other users.

The social media content analyzer module 40 is in communication with or monitors the first user's social networking site profile 50, including the first user's social media content 52 such as social media contents, videos, blogs, chats, personal archives, etc. The social media content analyzer module 40 may also be in communication with or monitor other user profiles who are members of a social network community that the first user 20 is also a member.

The social media content analyzer module 40 analyzes content or objects within the social media content that is uploaded by the second user 22. The social media content analyzer module 40 determines/detects whether the first user 20 is associated with the social media content based on a description, generated by the social media content analyzer module 40. The social media content analyzer module 40 detects characteristics, objects, entities, and content within the social media content. The social media content description and characteristics are stored in the first user's social media content database. The social media content analyzer module 40 may analyze the social media content by using a computer vision algorithm such as convolutional neural network and may use natural language processing.

The community-based access analyzer module 42, in response to the social media content analyzer module 40 identifying or associating the first user 20 with the social media content, automatically detects at least one social network community within which the social media content may be published and at least one social network community within which the social media content is inhibited from being published or is blocked access to the social media content. The community-based access analyzer module 42 classifies the social media content associated with the first user 20 into social media community based categories to determine which social network communities and users of those social network communities have permission to access the social media content associated with the first user 20. The second user 22, the third user 24, and the another user 26 are inhibited access to the social media content if they are not associated with the at least one social network community as classified by the social media content analyzer module 40. The community-based access analyzer module 42 is in communication with or monitors the first user's social network communities 54 and the social network communities of other users connected to the first user 20.

The community-based access analyzer module 42 outputs for display to the first user 20, a first notification 56. The first notification 56 notifies the first user 20 that social media content associated with the first user 20 has been received by the social networking site 10. The first notification 56 includes a prompt to the first user 20 to permit or inhibit access to the social media content associated with the first user 20. In at least one embodiment, the first user's response to the prompt is used to update a classification algorithm of the social media content analyzer module 40.

The community-based access analyzer module 42 outputs for display to the second user 22, the third user 24, or the another user 26 that uploads or provides social media content associated with the first user 20, a second notification 58. The second notification 58 notifies the social media content uploader or provider of the social media content associated with the first user 20 whether the first user 20 has permitted to access or inhibited from accessing to the social media content associated with the first user 20.

The propagation analyzer module 44 determines the impact of propagation of the social media content associated with the first user 20. The propagation analyzer module 44 is in communication with the community-based analyzer module 42 and is in communication with or monitors the first user's social network communities 54. The propagation analyzer module 44 analyzes the number of potential users that will have access the social media content associated with the first user 20. The propagation analyzer module 44 assesses how quickly these users may obtain access to the social media content associated with the first user 20. The propagation analyzer module 44 aids the social media content analyzer module 40 and the community-based access analyzer module 42 in classifying the social media content associated with the first user 20 into at least one social network community.

The propagation analyzer module 44 implements a learning algorithm that generates a score for an impact propagation of the social media content associated with the first user 20 within at least one social network community. The impact propagation score provides a ranking as to the likelihood as to which social network communities the social media content associated with the first user 20 may be propagated into and a number of users that may access the social media content associated with the first user 20.

The propagation analyzer module 44 outputs for display a propagation notification to the first user 20. The propagation notification notifies the first user 20 as to the social network communities that the social media content associated with the first user 20 is most likely to be published or further disseminated within and the users that are permitted to access the social media content associated with the first user 20. The propagation notification notifies the first user 20 as to which social network communities that the social media content associated with the first user 20 is inhibited from being accessed.

The propagation notification enables the first user 20 to modify which social network communities may access the social media content associated with the first user 20. In at least one embodiment, the propagation notification outputs for display a list of potential social network communities that the social media content associated with the first user 20 is to be published and a list of social network communities inhibited from accessing the social media content associated with the first user 20.

The tag/posts/comments analyzer module 46 analyzes tags, posts, or comments associated with the social media content associated with the first user 20. The tag/posts/comments analyzer module 46 is in communication with the social media content analyzer module 40, the propagation analyzer module 44, user's tags, posts, comments 60 associated with the social media content associated with the first user 20, and other users posts associated with the social media content associated with the first user 20.

The tag/posts/comments analyzer module 46 analyzes a sentiment or topic of the tags, posts, or comments associated with the social media content associated with the first user 20. The tag/posts/comments analyzer module 46 detects the sentiment and topics and associates the tags, posts, or comments with the impact propagation score of the social network communities that the social media content associated with the first user 20 is permitted to be published within.

For example, should the second user 22 post an image associated with the first user 20 where the first user 20 is at a bar and having a drink. The third user 24 or another user 26 posts a comment poking fun at the first user 20 for having the drink. The tag/posts/comments analyzer module 46 determines if the comment is negative or positive, in this instance the comment is negative. The tag/posts/comments analyzer module 46 inhibits access to the image associated with the first user 20.

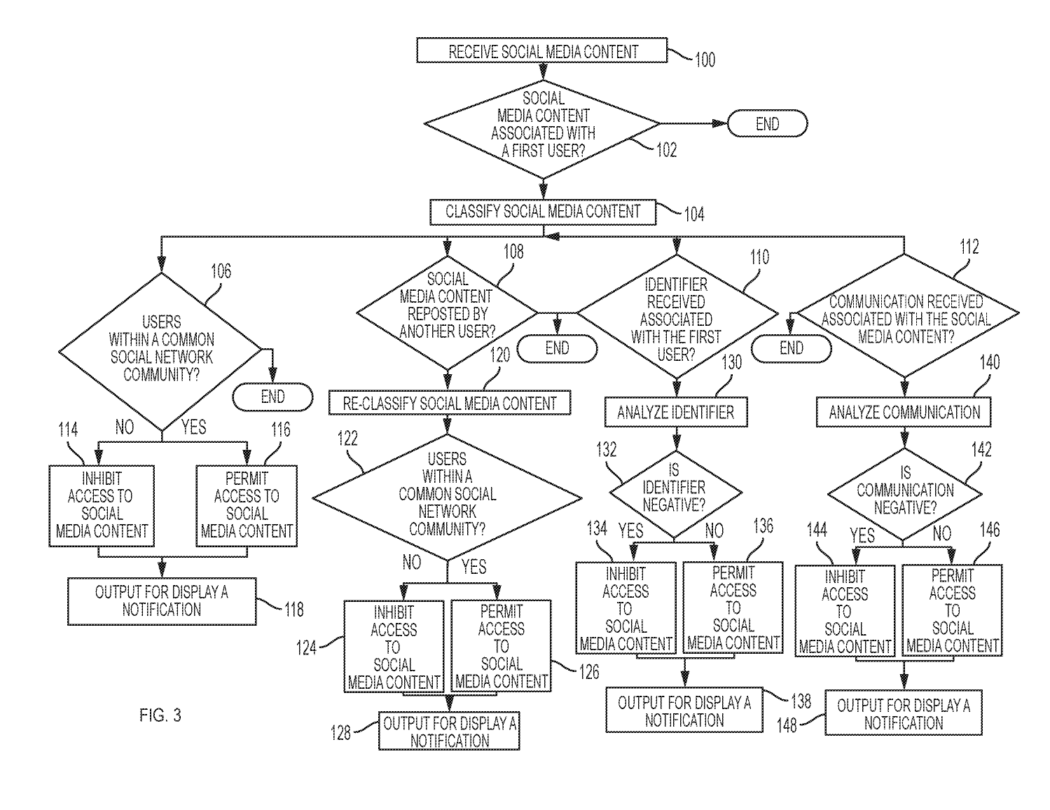

Referring to FIG. 3, a flowchart for the selective dissemination of social media content according to an embodiment of the present invention is shown. The flowchart demonstrates an exemplary system response to receipt of social media content associated with a first user 20. The at least one processor is programmed to perform the method outlined below.

At block 100, an image or other social media content, is received at the social networking site 10. The social media content is provided by at least one of a second user 22, a third user 24, and another user 26. At block 102, the social media content analyzer module 40 analyzes the social media content to determine if the social media content is associated with the first user 20. If the social media content is not associated with the first user 20, the method may end. Should the social media content be associated with the first user 20, the method continues to block 104.

At block 104, the social media content associated with the first user 20 is classified into at least one social network community. The social media content associated with the first user 20 is classified into at least one social network community by the social media content analyzer module 40. The method continues to at least one of block 106, block 108, block 110, and block 112 after the social media content associated with the first user 20 is classified into at least one social network community.

At block 106, the method determines, based on an analysis performed by the community-based access analyzer module 42 and the propagation analyzer module 44, whether the second user 22, the third user 24, or the another user 26 is associated with a common social network community with the first user 20 or the at least one social network community as classified by the social media content analyzer module 40. If the second user 22, the third user 24, or the another user 26 is not associated the at least one social network community classified by the social media content analyzer module 40, the method continues to block 114. Should the second user 22, the third user 24, or the another user 26 be associated with the at least one social network community as classified by the social media content analyzer module 40, the method continues to block 116.

At block 114, the second user 22, the third user 24, or the another user 26 are inhibited from accessing the social media content associated with the first user 20. At block 116, the second user 22, the third user 24, or the another user 26 are permitted to access the social media content associated with the first user 20.

At block 118, the method outputs for display a notification to at least one of the first user 20 and the second user 22. The notification to the first user 20 notifies the first user 20 as to the inhibiting of access to the second user 22, the third user 24, or the another user 26. The notification enables the first user 20 to permit or further inhibit access to the social media content associated with the first user 20 by other users.

At block 108, the method determines whether the social media content associated with the first user 20 has been re-posted by the second user 22, the third user 24, or the another user 26. If the social media content associated with the first user 20 has not been re-posted by the second user 22, the third user 24, or the another user 26 the method may end. Should the social media content associated with the first user 20 have been re-posted by the second user 22, the third user 24, or the another user 26, the method continues to block 120.

At block 120, the method re-classifies the social media content associated with the first user 20. In re-classifying the social media content associated with the first user 20, the system 30 updates the classification of the social media content associated with the first user 20 into at least one social network community, updates the propagation impact analysis, and then updates the at least one social network community and users that are permitted to or inhibited from accessing the social media content associated with the first user 20.

At block 122, the method determines, whether the second user 22, the third user 24, or the another user 26 is within a common social network community with the first user 20. If the second user 22, the third user 24, or the another user 26 is not associated with the at least one social network community as classified by the social media content analyzer module 40, the method continues to block 124. Should the second user 22, the third user 24, or the another user 26 be associated with the at least one social network community as classified by the social media content analyzer module 40 and the second user 22, the third user 24, or the another user 26 is permitted access to the social media content associated with the first user 20, the method continues to block 126.

At block 124, the second user 22, the third user 24, or the another user 26 are inhibited from accessing the social media content associated with the first user 20. At block 126, the second user 22, the third user 24, or the another user 26 is permitted access to the social media content associated with the first user 20.

At block 128, the method outputs for display another notification to at least one of the first user 20 and the second user 22. The notification to the first user 20 notifies the first user 20 as to the inhibiting of access to the second user 22, the third user 24, or the another user 26. The notification enables the first user 20 to permit or further inhibit access to the social media content associated with the first user 20 by other users.

At block 130, the method determines whether an identifier associated with the social media content associated with the first user 20 has been received. The identifier is a tag, a post, or the like that identifies the first user 20 as being within or the subject of the social media content associated with the first user 20. If an identifier associated with the social media content associated with the first user 20 has not been received, the method may end. Should an identifier associated with the social media content associated with the first user 20 have been received, the method may continue to block 130.

At block 130, the method analyzes the identifier associated with social media content associated with the first user 20. The identifier associated with the social media content associated with the first user 20 is analyzed to determine a sentiment and content of the identifier.

At block 132, the method determines, whether the identifier is negative. If the identifier associated with the social media content associated with the first user 20 is negative, the method continues to block 134. Should the identifier associated with the social media content associated with the first user 20 be positive or neutral, the method continues to block 136. In at least one embodiment, the method may output for display a notification to the first user 20 that enables the first user 20 to permit or inhibit access to the social media content associated with the first user 20 based on a preview of the identifier.

At block 134, the second user 22, the third user 24, or the another user 26 are inhibited from accessing to the social media content associated with the first user 20. At block 136, the second user 22, the third user 24, or the another user 26 is permitted access to the social media content associated with the first user 20.

At block 138, the method outputs for display yet another notification to at least one of the first user 20 and the second user 22. The notification to the first user 20 notifies the first user 20 as to the inhibiting of access to the second user 22, the third user 24, or the another user 26. The notification enables the first user 20 to permit or further inhibit access to the social media content associated with the first user 20 by other users.

At block 112, the method determines whether a communication associated with the social media content associated with the first user 20 has been received. The communication is a comment, a post, or the like that provides remarks, opinions, or sentiments concerning the social media content associated with the first user 20. If a communication associated with the social media content associated with the first user 20 has not been received, the method may end. Should a comment associated with the social media content associated with the first user 20 have been received, the method may continue to block 140.

At block 140, the method analyzes the comment associated with social media content associated with the first user 20. The comment associated with the social media content associated with the first user 20 is analyzed to determine a sentiment and the content of the comment.

At block 142, the method determines, whether the comment is negative. If the comment associated with the social media content associated with the first user 20 is negative, the method continues to block 144. Should the comment associated with the social media content associated with the first user 20 be positive or neutral, the method continues to block 146. In at least one embodiment, the method may output for display a notification to the first user 20 that enables the first user 20 to permit or inhibit access to the social media content associated with the first user 20 based on a preview of the comment.

At block 144, the second user 22, the third user 24, or the another user 26 are inhibited from accessing to the social media content associated with the first user 20. At block 146, the second user 22, the third user 24, or the another user 26 is permitted access to the social media content associated with the first user 20.

At block 148, the method outputs for display yet another notification to at least one of the first user 20 and the second user 22. The notification to the first user 20 notifies the first user 20 as to the inhibiting of access to the second user 22, the third user 24, or the another user 26. The notification enables the first user 20 to permit or further inhibit access to the social media content associated with the first user 20 by other users.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

As used herein, the articles “a” and “an” preceding an element or component are intended to be nonrestrictive regarding the number of instances (i.e. occurrences) of the element or component. Therefore, “a” or “an” should be read to include one or at least one, and the singular word form of the element or component also includes the plural unless the number is obviously meant to be singular.

As used herein, the terms “invention” or “present invention” are non-limiting terms and not intended to refer to any single aspect of the particular invention but encompass all possible aspects as described in the specification and the claims.

As used herein, the term “about” modifying the quantity of an ingredient, component, or reactant of the invention employed refers to variation in the numerical quantity that can occur, for example, through typical measuring and liquid handling procedures used for making concentrates or solutions. Furthermore, variation can occur from inadvertent error in measuring procedures, differences in the manufacture, source, or purity of the ingredients employed to make the compositions or carry out the methods, and the like. In one aspect, the term “about” means within 10% of the reported numerical value. In another aspect, the term “about” means within 5% of the reported numerical value. Yet, in another aspect, the term “about” means within 10, 9, 8, 7, 6, 5, 4, 3, 2, or 1% of the reported numerical value.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method for selective dissemination of social media content, the method comprising:
receiving social media content associated with a first user at a social networking site;
classifying the social media content associated with the first user into at least one social network community;
inhibiting access to the social media content associated with the first user by at least one of a second user and another user that is not associated with the at least one social network community; and
outputting for display a first notification to the first user.

2. The computer implemented method of claim 1, wherein the second user provides the social media content associated with the first user to the social networking site.

3. The computer implemented method of claim 1, wherein classifying the social media content associated with the first user is based on an impact propagation of the social media content associated with the first user within at least one social network community.

4. The computer implemented method of claim 3, further comprising outputting for display a propagation notification, based on the impact propagation of the social media content associated with the first user, to the first user, the propagation notification indicative of at least one of a list of potential social network communities that the social media content associated with the first user is to be published within and a list of social network communities inhibited from accessing the social media content associated with the first user.

5. The computer implemented method of claim 3, further comprising analyzing a sentiment of a communication associated with the social media content associated with the first user provided by at least one of the second user and another user.

6. The computer implemented method of claim 5, further comprising inhibiting access to the social media content associated with the first user by at least one of the second user and another user based on the sentiment of the communication associated with the social media content and the impact propagation.

7. The computer implemented method of claim 1, wherein in response to a re-posting of the social media content associated with the first user by another user, re-classifying the social media content associated with the first user into at least one social network community and inhibiting access to the social media content associated with the first user by at least one of the second user and another user that is not associated with the at least one social network community.

8. The computer implemented method of claim 1, wherein the first notification includes a prompt to the first user to permit access to the social media content associated with the first user by at least one of the second user and another user.

9. The computer implemented method of claim 1, further comprising outputting for display a second notification indicative of inhibiting access to the social media content associated with the first user to the second user.

10. The computer implemented method of claim 1, further comprising analyzing an identifier associated with the first user provided by at least one of the second user and another user.

11. The computer implemented method of claim 10, further comprising inhibiting access to the social media content associated with the first user by at least one of the second user and another user based on the identifier associated with the social media content associated with the first user.

12. A computer program product for selective dissemination of social media content, the computer program product comprising a computer readable storage medium having program instructions embodied therewith, the program instructions executable by at least one processor to perform a method comprising:
responsive to receiving social media content associated with a first user at a social networking site from a second user, classifying the social media content associated with the first user into at least one social network community;
analyzing a communication associated with the social media content associated with the first user provided by at least one of the second user and another user;
inhibiting access to the social media content by at least one of the second user and another user that is not associated with the at least one social network community based on the communication associated with the social media content associated with the first user; and
outputting for display a first notification to the first user.

13. The computer program product of claim 12, wherein the social media content is classified into at least one social network community based on characteristics of the social media content.

14. The computer program product of claim 12, further comprising
analyzing an identifier associated with the social media content associated with the first user provided by at least one of the second user and another user; and
inhibiting access to the social media content associated with the first user by at least one of the second user and another user based on a sentiment of the communication associated with the social media content.

15. The computer program product of claim 12, further comprising
analyzing an identifier associated with the social media content associated with the first user provided by at least one of the second user and another user; and
inhibiting access to the social media content associated with the first user by at least one of the second user and another user based on the identifier associated with the social media content associated with the first user.

16. A system for selective dissemination of social media content, the system comprising:
at least one processor operatively connected to a computer readable storage medium, the at least one processor programmed to:
responsive to receiving social media content associated with a first user at a social networking site from a second user, classify the social media content associated with the first user into at least one social network community;
analyze a communication associated with the social media content associated with the first user provided by at least one of the second user and another user;
inhibit access to the social media content associated with the first user by at least one of the second user and another user not within the at least one social network community based on a sentiment of a communication associated with the social media content associated with the first user; and
outputting for display a notification to at least one of the first user and the second user.

17. The system of claim 16, wherein the at least one processor is further programmed to, analyze propagation of the social media content associated with the first user within at least one social network community based on a number of potential users that will access the social media content associated with the first user.

18. The system of claim 17, wherein access to the social media content associated with the first user is further inhibited based on the number of potential users that will access the social media content associated with the first user.

19. The system of claim 16, wherein the at least one processor is further programmed to, responsive to another user of the at least one social network community re-posting the social media content associated with the first user, re-classify the social media content associated with the first user into at least one social network community.

20. The system of claim 16, wherein the at least one processor is further programmed to, notify a first user as to the inhibiting access to the social media content associated with the first user.
